(19) United States
(12) Patent Application Publication
(10) Pub. No.: US 2014/0205877 A1
(43) Pub. Date: Jul. 24, 2014

(54) RECHARGEABLE BATTERY

(71) Applicants: ROBERT BOSCH GMBH, Stuttgart (DE); SAMSUNG SDI CO., LTD., Yongin-si (KR)

(72) Inventor: Sung-Kab KIM, Yongin-si (KR)

(21) Appl. No.: 13/921,517

(22) Filed: Jun. 19, 2013

(30) Foreign Application Priority Data
Jan. 21, 2013 (KR) 10-2013-0006656

(51) Int. Cl. H01M 2/02; H01M 2/12

(52) U.S. Cl. CPC H01M 2/02; H01M 2/1241; H01M 2/0217; H01M 2/024
USPC 429/82; 429/179

(57) ABSTRACT

A rechargeable battery includes an electrode assembly, a case receiving the electrode assembly, a cap plate combined to the case, the cap plate including an opening and a bending inducing groove extending to a side of the cap plate from a side of the opening, and an electrode terminal installed in a terminal hole of the cap plate.

### CROSS-REFERENCE TO RELATED APPLICATION

This application claims the benefit under 35 U.S.C. §119 of and priority to Korean Patent Application No. 10-2013-0006656, filed on Jan. 21, 2013, in the Korean Intellectual Property Office, and entitled: “Rechargeable Battery,” which is incorporated by reference herein in its entirety.

### BACKGROUND

1. Field

Embodiments relate to a rechargeable battery.

2. Description of the Related Art

Unlike a primary battery, a rechargeable battery may repeatedly perform charging and discharging. A small-capacity rechargeable battery may be used in a portable small-sized electronic device such as a mobile phone, a notebook computer, and a camcorder, and a large-capacity rechargeable battery may be used as a power supply for driving a motor such as a hybrid vehicle or an electric vehicle.

The above information disclosed in this Background section is only for enhancement of understanding of the background of the described technology and therefore it may contain information that does not form the prior art that is already known in this country to a person of ordinary skill in the art.

### SUMMARY

Embodiments are directed to a rechargeable battery, including an electrode assembly, a case receiving the electrode assembly, a cap plate combined to the case, the cap plate including an opening and a bending inducing groove extending to a side of the cap plate from a side of the opening, and an electrode terminal installed in a terminal hole of the cap plate.

The cap plate may include a short side and a long side corresponding to the case, and the bending inducing groove may be disposed on respective sides of the opening on a same line.

The bending inducing groove may be disposed in parallel with the short side.

The bending inducing groove may include a vertical surface vertically disposed relative to a top surface of the cap plate, and a slanted surface extending from a bottom of the vertical surface to the top surface of the cap plate with a predetermined angle.

The bending inducing groove may include a first bending inducing groove disposed at a top surface of the cap plate, and a second bending inducing groove disposed at a bottom surface of the cap plate corresponding to the first bending inducing groove.

A first thickness T1 that is set at a lowest bottom of the first bending inducing groove may be greater than a second thickness T2 that is set at a highest top of the second bending inducing groove.

The first bending inducing groove may include a first vertical surface vertically disposed relative to a top surface of the cap plate, and a first slanted surface extending from a bottom of the first vertical surface to the top surface of the cap plate with a predetermined first angle, and the second bending inducing groove may include a second vertical surface vertically disposed relative to a bottom surface of the cap plate, and a second slanted surface corresponding to the first slanted surface and extending from the top of the second vertical surface toward the bottom surface of the cap plate with a predetermined second angle.

The first angle may be greater than the second angle.

The opening may correspond to a vent hole in which a vent plate that is opened when an internal pressure of the case exceeds a predetermined value is installed, and the bending inducing groove may be connected to a side of the cap plate on respective sides of the vent hole.

The bending inducing groove may extend continuously from the opening to a side of the cap plate.

The bending inducing groove may include plural discrete grooves on each side of the opening, the discrete grooves being disposed along a line from the opening to a side of the cap plate.

The opening may have a vent plate therein, the vent plate being configured to release an internal pressure of the battery if an internal pressure of the case exceeds a predetermined value, and the opening may penetrate the cap plate, and the bending inducing groove may include first and second groove portions that respectively extend from opposite sides of the opening to respective first and second points where opposite edges of the cap plate meet the case, the first and second groove portions each having a depth in the cap plate that is less than a thickness of the cap plate such that the first and second groove portions do not penetrate the cap plate.

### BRIEF DESCRIPTION OF THE DRAWINGS

Features will become apparent to those of skill in the art by describing in detail example embodiments with reference to the attached drawings in which:

FIG. 1 illustrates a perspective view of a rechargeable battery according to a first example embodiment.

FIG. 2 illustrates a cross-sectional view with respect to a line II-II of FIG. 1.

FIG. 3 illustrates a perspective view of a cap plate applied to FIG. 1 and FIG. 2.

FIG. 4 illustrates a cross-sectional view with respect to a line IV-IV of FIG. 3.

FIG. 5 illustrates a deformation state diagram of a cap plate shown in FIG. 4.

FIG. 6 illustrates a partial cross-sectional view of a cap plate applicable to a rechargeable battery according to a second example embodiment.

FIG. 7 illustrates a deformation state diagram of a cap plate shown in FIG. 6.

FIG. 8 illustrates a partial cross-sectional view of a cap plate applied to a rechargeable battery according to a third example embodiment.

FIG. 9 illustrates a deformation state diagram of a cap plate shown in FIG. 8.

FIG. 10 illustrates a perspective view of a cap plate applicable to a rechargeable battery according to a fourth example embodiment.

FIG. 11 illustrates a cross-sectional view with respect to a line XI-XI of FIG. 10.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey example implementations to those skilled in the art. In the drawing figures, the dimensions of layers and regions may be exaggerated for clarity of illustration. Like reference numerals refer to like elements throughout.

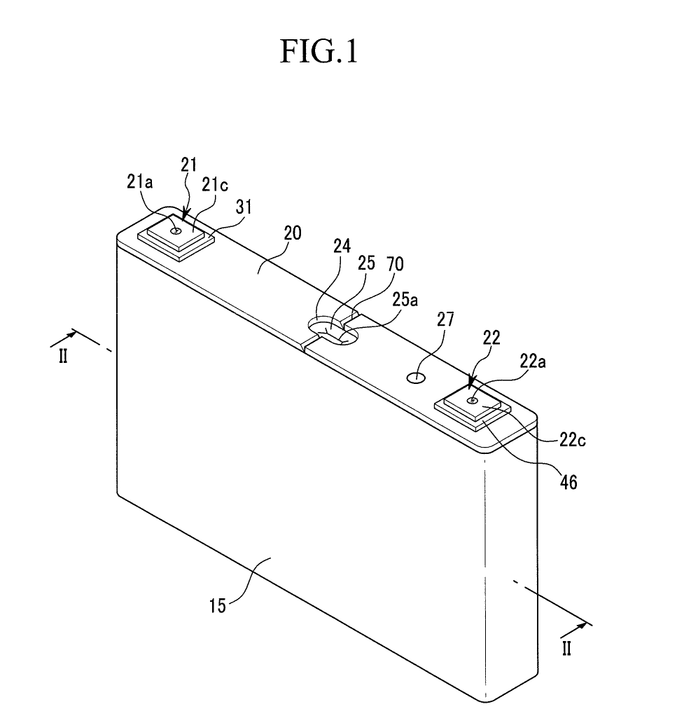

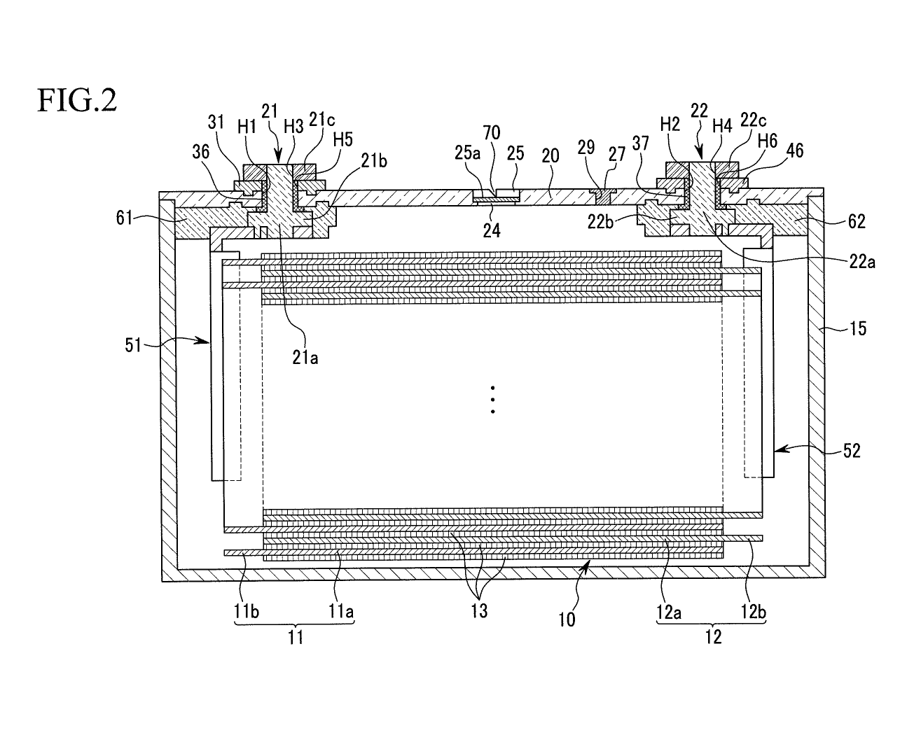

FIG. 1 illustrates a perspective view of a rechargeable battery according to a first example embodiment and FIG. 2 shows a cross-sectional view with respect to a line II-II of FIG. 1.

In the example embodiment shown in FIG. 1 and FIG. 2, the rechargeable battery includes an electrode assembly 10 for charging and discharging a current, a case 15 for receiving the electrode assembly 10, a cap plate 20 combined to an open unit of the case 15, and electrode terminals (e.g., a negative terminal 21 and a positive terminal 22) installed on the cap plate 20.

For example, the electrode assembly 10 may be formed by disposing a negative electrode 11 and a positive electrode 12 on both sides of a separator 13 which is an insulator and spirally winding the negative electrode 11, the separator 13, and the positive electrode 12 in a jellyroll state.

The negative electrode 11 and the positive electrode 12 include coated regions 11a and 12a generated by coating an active material on a current collector of a metal plate, and uncoated regions 11b and 12b on which the active material is not coated and which are formed as exposed current collectors.

The uncoated region 11b of the negative electrode 11 is formed on one end of the negative electrode 11 along the spirally wound negative electrode 11. The uncoated region 12b of the positive electrode 12 is formed on one end of the positive electrode 12 along the spirally wound positive electrode 12. The uncoated regions 11b and 12b are disposed on respective ends of the electrode assembly 10.

For example, the case 15 may be formed to be prismatic so as to form a space for receiving the electrode assembly 10 and an electrolyte solution, and has an open unit for communicating an outside and the inner space on one side. The open unit allows the electrode assembly 10 to be inserted inside the case 15.

The cap plate 20 is installed in the open unit of the case 15 to close and seal the case 15. For example, the case 15 and the cap plate 20 may be made of aluminum and be welded to each other.

In the present example embodiment, the cap plate 20 includes at least one opening. For example, it includes an electrolyte injection opening 29, a vent hole 24, and terminal holes H1 and H2. The electrolyte injection opening 29 communicates the outside of the cap plate 20 and the inside of the case 15 to allow the electrolyte solution to be injected into the case 15. When the electrolyte solution is injected, the electrolyte injection opening 29 is sealed with a sealing stopper 27.

The negative terminal 21 and the positive terminal 22 are installed in the terminal holes H1 and H2 of the cap plate 20, and are electrically connected to the electrode assembly 10. Thus, the negative terminal 21 is electrically connected to the negative electrode 11 of the electrode assembly 10, and the positive terminal 22 is electrically connected to the positive electrode 12 of the electrode assembly 10. Therefore, the electrode assembly 10 is drawn out to the outside of the case 15 through the negative terminal 21 and the positive terminal 22.

The negative terminal 21 and the positive terminal 22 form the same configuration inside the cap plate 20, and they form different configurations outside the cap plate 20, which will now be described.

In the present example embodiment, the negative and positive terminals 21 and 22 include plate terminals 21c and 22c disposed outside the cap plate 20 corresponding to the terminal holes H1 and H2, and rivet terminals 21a and 22a electrically connected to the electrode assembly 10 and fastened (for example, riveted or welded) to the plate terminals 21c and 22c by passing through the terminal holes H1 and H2.

The plate terminals 21c and 22c have through holes H3 and H4, and upper ends of the rivet terminals 21a and 22a are inserted in the through-holes H3 and H4 by passing through the terminal holes H1 and H2. The negative and positive terminals 21 and 22 further include flanges 21b and 22b widely and integrally formed with the rivet terminals 21a and 22a inside the cap plate 20.

Negative and positive gaskets 36 and 37 are installed between the rivet terminals 21a and 22a of the negative and positive terminals 21 and 22 and the insides of the terminal holes H1 and H2 of the cap plate 20 to seal and electrically insulate a space between the rivet terminals 21a and 22a of the negative and positive terminals 21 and 22 and the cap plate 20.

The negative and positive gaskets 36 and 37 are extended to be installed between the flanges 21b and 22b and the inside of the cap plate 20 to further seal and electrically insulate the space between the flanges 21b and 22b and the cap plate 20. Thus, the negative and positive gaskets 36 and 37 prevent an electrolyte solution from being leaked through the terminal holes H1 and H2 when installing the negative and positive terminals 21 and 22 in the cap plate 20.

Negative and positive lead tabs 51 and 52 electrically connect the negative and positive terminals 21 and 22 to the negative and positive electrodes 11 and 12 of the electrode assembly 10. Thus, the negative and positive lead tabs 51 and 52 are combined to bottoms of the rivet terminals 21a and 22a and the bottoms are caulked so that the negative and positive electrode lead tabs 51 and 52 are supported by the flanges 21b and 22b and are connected to the rivet terminals 21a and 22a.

Negative and positive insulation members 61 and 62 are installed between the negative and positive electrode lead tabs 51 and 52 and the cap plate 20 to electrically insulate the negative and positive electrode lead tabs 51 and 52 from the cap plate 20. Further, the negative and positive electrode insulating members 61 and 62 are combined to the cap plate 20 on a first end and wrap the negative and positive electrode lead tabs 51 and 52, the rivet terminals 21a and 22a, and the flanges 21b and 22b thereby stabilizing their connection structure.

An external insulation member 31 is provided between the plate terminal 21c on the side of the negative terminal 21 and the cap plate 20 to electrically insulate the plate terminal 21c and the cap plate 20. Thus, the cap plate 20 maintains a state of electrical insulation from the negative terminal 21.

The external insulation member 31 further forms a through hole H5 corresponding to the terminal hole H1 and the through hole H3. Therefore, the rivet terminal 21a penetrates through the terminal hole H1 and the through holes H5 and H3. The negative electrode gasket 36 penetrates through the terminal hole H1 and the through hole H5.

The external insulation member 31 and the plate terminal 21c are combined to the top of the rivet terminal 21a to rivet or weld the top so the external insulation member 31 and the plate terminal 21c are fastened to the top of the rivet terminal 21a. The plate terminal 21c is installed outside the cap plate 20 with provision of the external insulating member 31.

A conductive top plate 46 is provided between the plate terminal 22c on the side of the positive terminal 22 and the cap plate 20 to electrically connect the plate terminal 22c and the cap plate 20. Thus, the cap plate 20 maintains the electrically connected state to the positive terminal 22.

The top plate 46 further forms a through hole H6 corresponding to the terminal hole H2 and the through hole H4. Therefore, the rivet terminal 22a penetrates through the terminal hole H2 and the through holes H6 and H4. The positive gasket 37 penetrates through the terminal hole H2 and the through hole H6.

The top plate 46 and the plate terminal 22c are combined to the top of the rivet terminal 22a to rivet or weld the top so the top plate 46 and the plate terminal 22c are fastened to the top of the rivet terminal 22a. The plate terminal 22c is installed outside the cap plate 20 on the top plate 46.

The positive gasket 37 prevents the rivet terminal 22a and the top plate 46 from being electrically directly connected to each other. Thus, the rivet terminal 22a is electrically connected to the top plate 46 through the plate terminal 22c. Therefore, the top plate 46 and the case 15 may have a positive polarity.

In the present example embodiment, the vent hole 24 is closed and sealed by a vent plate 25 so as to discharge an internal pressure of the rechargeable battery and gas, e.g., if the internal pressure of the rechargeable battery reaches a predetermined pressure, then the vent plate 25 may be incised, split, or otherwise opened to open the vent hole 24. In the present example embodiment, the vent plate 25 includes a notch 25a for causing an incision.

In the present example embodiment, the cap plate 20 includes a bending inducing groove 70 formed at sides of one of the openings and disposed to an end, i.e., side, of the cap plate 20. For example, the bending inducing groove 70 may be formed at sides of the electrolyte injection opening 29 or the vent hole 24.

The present example embodiment is described in connection with a configuration in which a bending inducing groove 70 is formed at a side of the vent hole 24, which forms a greater open area than that of the electrolyte injection opening 29. Therefore, the cap plate 20 may be bent in the vent hole 24 and the side of the bending inducing groove 70. In other words, as would be apparent to one of ordinary skill in the art from the foregoing description and FIGS. 1 and 2, the vent hole 24, which may penetrate the cap plate 20, may have the vent plate 25 therein, the vent plate 25 being configured to release an internal pressure of the battery if an internal pressure of the case 15 exceeds a predetermined value, and the bending inducing groove 70 may include first and second groove portions that respectively extend from opposite sides of the vent hole 24 to respective first and second points where opposite edges of the long sides of the cap plate 20 meet the case 15, the first and second groove portions each having a depth in the cap plate 20 that is less than a thickness of the cap plate 20 such that the first and second groove portions do not penetrate the cap plate 20.

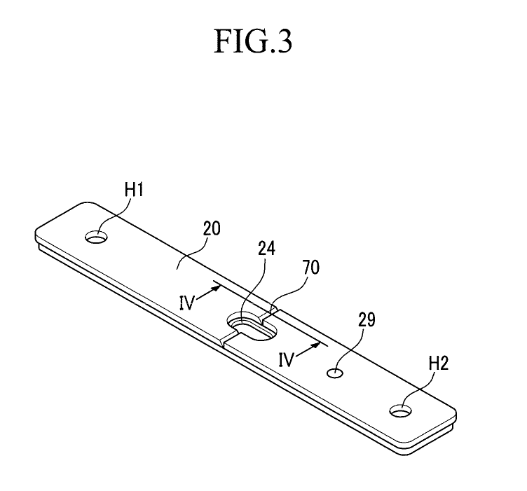

FIG. 3 shows a perspective view of a cap plate applied to FIG. 1 and FIG. 2.

In the example embodiment shown in FIG. 3, the cap plate 20 has a rectangular shape having a short side and a long side corresponding to the open unit of the case 15.

The bending inducing grooves 70 with provision of the vent hole 24 therebetween are formed on the same line on both sides of the vent hole 24. In this instance, the bending inducing groove 70 may be formed in parallel with the short side of the cap plate 20.

In the present example embodiment, when a load is applied to the short side of the case 15, the bending inducing groove 70 sets a bending position of the cap plate 20 according to the load transmitted to the cap plate 20. Therefore, the bending inducing groove 70 formed in parallel with the short side may induce bending of the cap plate 20 with the shortest distance that is set in a width direction of the cap plate 20.

Also, the bending inducing groove 70 may induce protruding deformation of the bent cap plate 20 to the outside of the case 15, and so may help prevent damage to the electrode assembly 10 caused by the deformed cap plate 20.

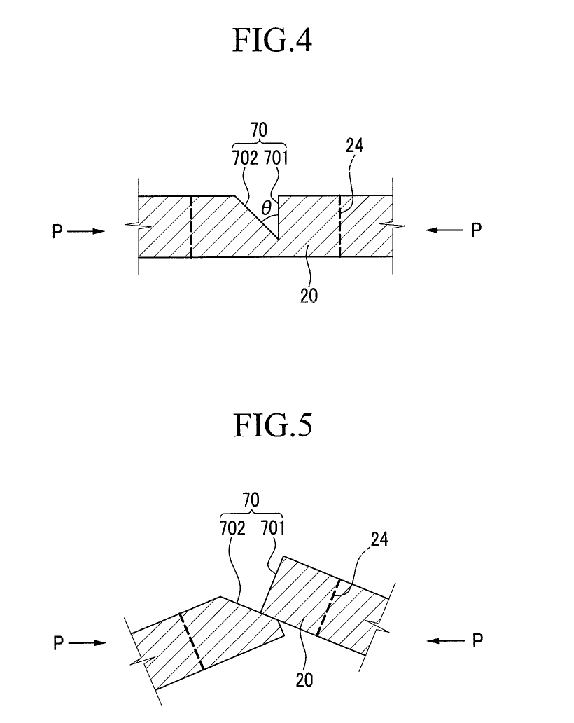

FIG. 4 illustrates a cross-sectional view with respect to a line IV-IV of FIG. 3, and FIG. 5 shows a deformation state diagram of a cap plate shown in FIG. 4.

In the example embodiment shown in FIG. 4 and FIG. 5, the bending inducing groove 70 includes a vertical surface 701 and a slanted surface 702.

In the present example embodiment, the vertical surface 701 is formed vertically downward on the top surface (external surface) of the cap plate 20, and the slanted surface 702 is formed toward the top surface (external surface) of the cap plate 20 with a predetermined angle (0) from a bottom of the vertical surface 701.

When a load is applied to the short side of the case 15, the bending inducing groove 70 may induce the cap plate 20 to be bent and protruded upward by the load (P) transmitted to the cap plate 20. Thus, in the cap plate 20, the bottom surface of the vertical surface 701 may become the thinnest and form a part that is weak in rigidity, and the bottom surface may be closed and the top surface may be opened to thus form the top surface that is weak in rigidity compared to the bottom surface.

In the present example embodiment, a left part of the bending inducing groove 70 having the vertical surface 701 goes up to a right part of the bending inducing groove 70 having the slanted surface 702 and the bending inducing groove 70 is protruded outside the case 15. Thus, when the cap plate 20 is bent, the electrode assembly 10 provided inside the case 15 may not be damaged by the bent cap plate 20. Safety of the electrode assembly 10 and the rechargeable battery may thus be maintained.

Second to fourth example embodiments will now be described. The same configurations as the first example embodiment and the described example embodiment will be omitted, and different configurations from the first example embodiment and the described example embodiment will now be described.

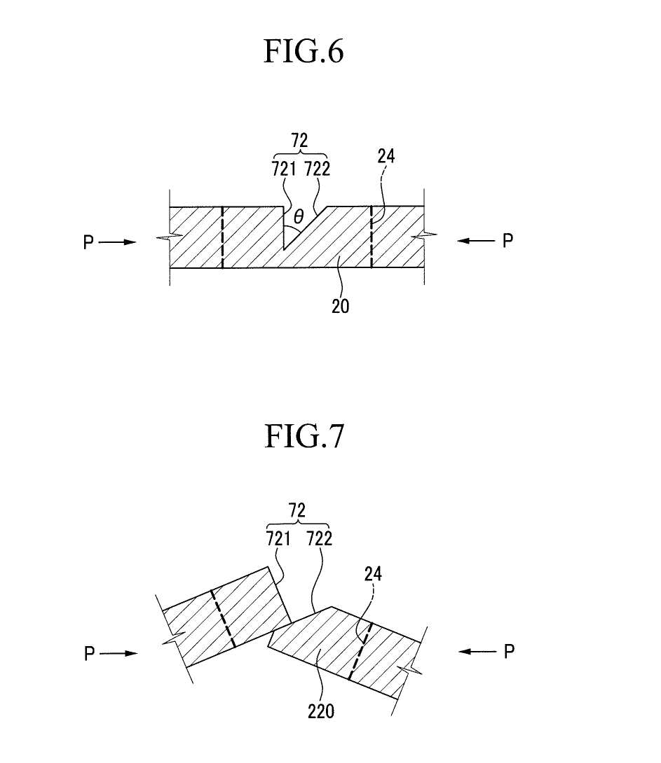

FIG. 6 illustrates a partial cross-sectional view of a cap plate applicable to a rechargeable battery according to a second example embodiment, and FIG. 7 shows a deformation state diagram of a cap plate shown in FIG. 6.

In the example embodiment shown in FIG. 6 and FIG. 7, in the cap plate 220, a bending inducing groove 72 includes a vertical surface 721 and a slanted surface 722.

In the present example embodiment, directions of the vertical surface 721 and the slanted surface 722 according to the second example embodiment are symmetric with the directions of the vertical surface 701 and the slanted surface 702 according to the first example embodiment.

When a load is applied to a short side of the case 15, the bending inducing groove 72 may induce the cap plate 220 to be bent and protruded upward by the load (P) transmitted to the cap plate 220. Thus, in the cap plate 220, the bottom surface of the vertical surface 721 may become the thinnest and form a part that is weak in rigidity, and the bottom surface may be closed and the top surface may be opened to thus form the top surface that is weak in rigidity compared to the bottom surface.

In the present example embodiment, a left part of the bending inducing groove 72 having the vertical surface 721 goes up to a right part of the bending inducing groove 72 having the slanted surface 722 and the bending inducing groove 72 is protruded outside the case 15. Thus, when the cap plate 220 is bent, the electrode assembly 10 provided inside the case 15 may not be damaged by the bent cap plate 220. Safety of the electrode assembly 10 and the rechargeable battery may thus be maintained.

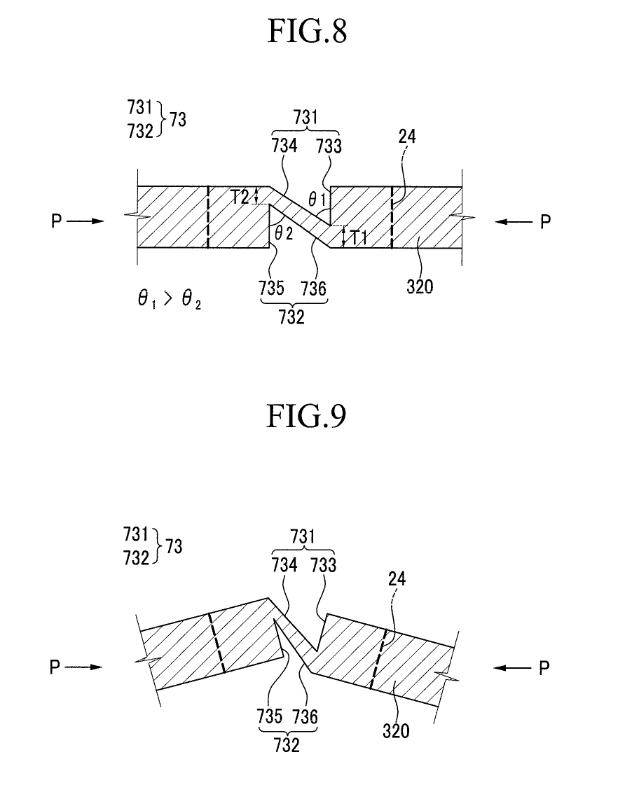

FIG. 8 illustrates a partial cross-sectional view of a cap plate applied to a rechargeable battery according to a third example embodiment, and FIG. 9 shows a deformation state diagram of a cap plate shown in FIG. 8.

In the example embodiment shown in FIG. 8 and FIG. 9, in the cap plate 320, the bending inducing groove 73 includes a first bending inducing groove 731 formed on a top surface (external surface) of the cap plate 320, and a second bending inducing groove 732 formed on a bottom surface (internal surface) of the cap plate 320 corresponding to the first bending inducing groove 731.

The first bending inducing groove 731 includes a first vertical surface 733 and a first slanted surface 734. The first vertical surface 733 is formed vertically downward on the top surface (external surface) of the cap plate 320, and the first slanted surface 734 is formed toward the top surface (external surface) of the cap plate 320 with a predetermined first angle (θ1) from a bottom of the first vertical surface 733.

The second bending inducing groove 732 includes a second vertical surface 735 and a second slanted surface 736. The second vertical surface 735 is formed vertically upward on the bottom surface (internal surface) of the cap plate 320, and the second slanted surface 736 is formed toward the bottom surface (internal surface) of the cap plate 320 at the top surface of the second vertical surface 735 with a predetermined second angle (θ2).

The top of the first slanted surface 734 is provided in the vertically upward direction of the second vertical surface 735, and the bottom of the second slanted surface 736 is provided in the vertically downward direction of the first vertical surface 733. In this instance, the first and second slanted surfaces 734 and 736 form a first thickness T1 and a second thickness T2 at respective ends. Thus, the first thickness T1 is set at the lowest bottom of the first bending inducing groove 731, and the second thickness T2 is set at the highest top of the second bending inducing groove 732. In this instance, the first thickness T1 is formed to be greater than the second thickness T2. In an implementation, the first angle (θ1) may be formed to be greater than the second angle (θ2).

In the present example embodiment, in the bending inducing groove 73 of the cap plate 320, the bottom of the first vertical surface 733 of the first bending inducing groove 731 having the first thickness T1 forms a part that is the thickest and the most rigid, and the top of the second vertical surface 735 of the second bending inducing groove 732 having the second thickness T2 forms a part that is the thinnest and the least rigid.

When a load is applied to the short side of the case 15, the first bending inducing groove 731 may be more rigid than the second bending inducing groove 732 by the load (P) transmitted to the cap plate 320 so the second bending inducing groove 732 may be protruded upward and induce bending of the cap plate 320.

In the present example embodiment, the first angle (θ1) of the first bending inducing groove 731 may increase, the second angle (θ2) of the second bending inducing groove 732 may decrease, and the bending inducing groove 73 may be protruded outside the case 15 from the cap plate 320.

In the first to third example embodiments, the bending inducing grooves 70, 72, and 73 may be connected to the ends of the cap plates 20, 220, and 320 at respective ends of the vent holes 24, 220, and 320, and may efficiently induce bending of the cap plates 20, 220, and 320.

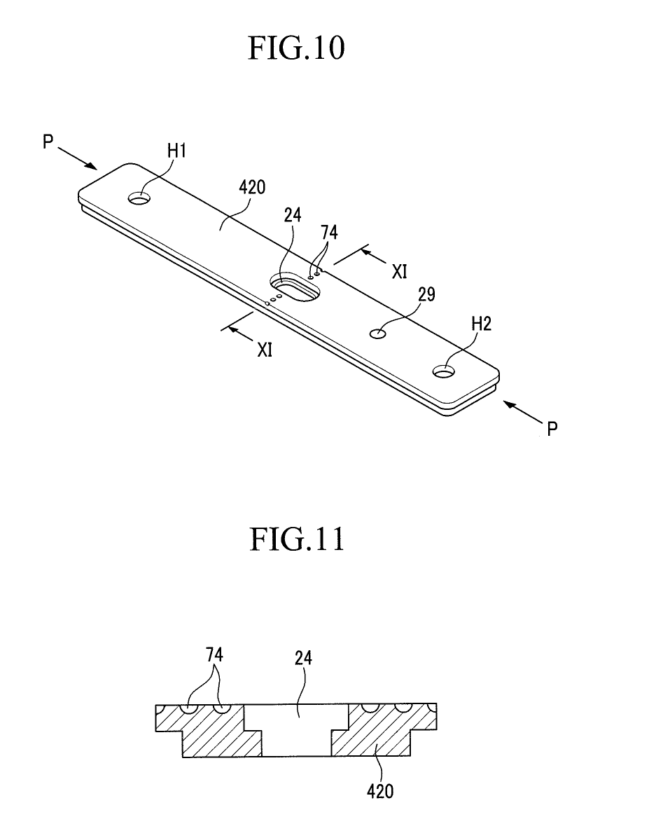

FIG. 10 illustrates a perspective view of a cap plate applicable to a rechargeable battery according to a fourth example embodiment, and FIG. 11 shows a cross-sectional view with respect to a line XI-XI of FIG. 10.

In the example embodiment shown in FIG. 10 and FIG. 11, in the cap plate 420, the bending inducing groove 74 is formed with grooves that are separately or discretely disposed to the end from respective sides of the vent hole 24.

For example, the grooves may be formed as respective concave grooves that are vertically downward in the top surface (external surface) of the cap plate 420 to deteriorate rigidity of the top surface (external surface) of the cap plate 420 for the load (P).

When a load is applied to the short side of the case 15, the bending inducing groove 74 may protrude upward and induce bending of the cap plate 420 by the load (P) transmitted to the short side of the cap plate 420. Thus, in the cap plate 420, grooves of the bending inducing groove 74 may form a part that is weak in rigidity, and bottom surfaces may be closed and top surfaces may be opened to form a part in which a top surface is weak in rigidity compared to the bottom surface. Therefore, the bending inducing groove 74 formed with separated grooves may be protruded outside the case 15.

In the present example embodiment, the bending inducing grooves 70, 72, and 73 are connected to the ends of the cap plates 20, 220, and 320 from the respective sides of the vent hole 24 in the first to third example embodiments, and the bending inducing groove 74 is separately disposed along the end of the cap plate 420 from the respective sides of the vent hole 24 in the fourth example embodiment. In the fourth example embodiment, the bending inducing groove 74 may likewise be bent outside the case 15, which may help prevent the electrode assembly 10 from being damaged by the bent cap plate 420.

By way of summation and review, a rechargeable battery may include an electrode assembly including electrodes at both surfaces of a separator, a case for accommodating the electrode assembly, and a cap plate coupled to an opening of the case, and an electrode terminal is installed in the cap plate to be connected to the electrode through a lead tab. The cap plate may include a terminal hole for installing an electrode terminal, an electrolyte injection opening for injecting an electrolyte solution and being sealed with a stopper, and a vent hole for installing a vent plate that is opened when internal pressure of the rechargeable battery exceeds a predetermined value. The cap plate may be deformable by an external force applied to a short side. For example, when a load is applied to a short side of a case, the cap plate may be deformed in the load direction. If the cap plate is deformed inside the case and the electrode assembly is damaged, and an internal short-circuit may be generated in the electrode assembly, and thermal runaway may be generated by gas that is internally generated.

As described above, embodiments may provide a rechargeable battery configured to guide deformation of a cap plate caused by a load that is operable at a short side of a case to outside of the case. Embodiments may provide a rechargeable battery for improving safety by preventing damage to an electrode assembly caused by a deformed cap plate. According to embodiments, a bending inducing groove may be formed at an opening of the cap plate so when a load is applied to the short side of the case, deformation of the cap plate may be induced to the outside of the case. Therefore, damage to the electrode assembly caused by the deformed cap plate may be reduced or prevented, and safety of the rechargeable battery may be improved.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A rechargeable battery, comprising:
an electrode assembly;
a case receiving the electrode assembly;
a cap plate combined to the case, the cap plate including an opening and a bending inducing groove extending to a side of the cap plate from a side of the opening; and
an electrode terminal installed in a terminal hole of the cap plate.

2. The rechargeable battery as claimed in claim 1, wherein:
the cap plate includes a short side and a long side corresponding to the case, and
the bending inducing groove is disposed on respective sides of the opening on a same line.

3. The rechargeable battery as claimed in claim 2, wherein the bending inducing groove is disposed in parallel with the short side.

4. The rechargeable battery as claimed in claim 1, wherein the bending inducing groove includes:
a vertical surface vertically disposed relative to a top surface of the cap plate; and
a slanted surface extending from a bottom of the vertical surface to the top surface of the cap plate with a predetermined angle.

5. The rechargeable battery as claimed in claim 1, wherein the bending inducing groove includes:
a first bending inducing groove disposed at a top surface of the cap plate; and
a second bending inducing groove disposed at a bottom surface of the cap plate corresponding to the first bending inducing groove.

6. The rechargeable battery as claimed in claim 5, wherein a first thickness T1 that is set at a lowest bottom of the first bending inducing groove is greater than a second thickness T2 that is set at a highest top of the second bending inducing groove.

7. The rechargeable battery as claimed in claim 5, wherein:
the first bending inducing groove includes:
a first vertical surface vertically disposed relative to a top surface of the cap plate; and
a first slanted surface extending from a bottom of the first vertical surface to the top surface of the cap plate with a predetermined first angle, and
the second bending inducing groove includes:
a second vertical surface vertically disposed relative to a bottom surface of the cap plate; and
a second slanted surface corresponding to the first slanted surface and extending from the top of the second vertical surface toward the bottom surface of the cap plate with a predetermined second angle.

8. The rechargeable battery as claimed in claim 7, wherein the first angle is greater than the second angle.

9. The rechargeable battery as claimed in claim 1, wherein:
the opening corresponds to a vent hole in which a vent plate that is opened when an internal pressure of the case exceeds a predetermined value is installed, and
the bending inducing groove is connected to a side of the cap plate on respective sides of the vent hole.

10. The rechargeable battery as claimed in claim 1, wherein the bending inducing groove extends continuously from the opening to a side of the cap plate.

11. The rechargeable battery as claimed in claim 1, wherein the bending inducing groove includes plural discrete grooves on each side of the opening, the discrete grooves being disposed along a line from the opening to a side of the cap plate.

12. The rechargeable battery as claimed in claim 1, wherein:
the opening has a vent plate therein, the vent plate being configured to release an internal pressure of the battery if an internal pressure of the case exceeds a predetermined value, and
the opening penetrates the cap plate, and the bending inducing groove includes first and second groove portions that respectively extend from opposite sides of the opening to respective first and second points where opposite edges of the cap plate meet the case, the first and second groove portions each having a depth in the cap plate that is less than a thickness of the cap plate such that the first and second groove portions do not penetrate the cap plate.
